(19) United States
(12) Patent Application Publication
(10) Pub. No.: US 2026/0244399 A1
(43) Pub. Date: Aug. 20, 2026

(54) Mobile Application for Detecting and Alerting Users of Narcissistic Comments

(71) Applicant: Jacquelyn Shurman, Gilbert, AZ (US)

(72) Inventor: Jacquelyn Shurman, Gilbert, AZ (US)

(21) Appl. No.: 19/543,877

(22) Filed: Feb. 19, 2026

Related U.S. Application Data
(60) Provisional application No. 63/758,979, filed on Feb. 14, 2025.

(51) Int. Cl. G06F 3/16; G06F 40/166; G06F 40/279

(52) U.S. Cl. CPC G06F 3/167; G06F 40/166; G06F 40/279

(57) ABSTRACT

A mobile device analyzes conversation content to detect predefined keywords or phrases associated with harmful or manipulative communication. The device receives audio via a microphone during an active monitoring session, converts the audio to text using speech-to-text processing, and compares the text to a user-configurable keyword list to determine a match. Upon detecting a match, the device generates an alert to the user via an audible tone, vibration, and/or a visual notification. In some embodiments, processing is performed locally on the device and the application does not store or transmit raw audio.

### CROSS-REFERENCE TO RELATED APPLICATIONS

This application claims the benefit of U.S. Provisional Application No. 63/758,979, filed Feb. 14, 2025.

### FIELD OF INVENTION

This invention relates to mobile applications and speech recognition technologies, specifically an application designed to monitor spoken conversations for predefined keywords or phrases associated with harmful or manipulative communication (including, in some examples, narcissistic communication) and provide real-time alerts to the user.

### BACKGROUND

Harmful or manipulative communication can negatively affect individuals, particularly in sensitive environments such as healthcare, therapy, and personal relationships. Many people struggle to recognize harmful or manipulative speech patterns in real time. This invention provides an immediate, customizable alert system that flags potentially harmful comments.

### SUMMARY OF INVENTION

The proposed mobile application uses speech recognition technology to analyze conversation content for predefined keywords or phrases. Conversation content is converted to text and compared against a keyword list to determine a match. Upon detection, the app generates an alert to notify the user. The application is initially based on a keyword-matching system; some embodiments integrate artificial intelligence (AI) and natural language processing (NLP) for more advanced detection capabilities.

### DETAILED DESCRIPTION

### 4.1 System Overview

When activated by a user and permitted by the operating system, the application receives audio via the device's microphone during an active monitoring session.
Users can input and customize a list of keywords or phrases they want the app to detect.
When a keyword is detected, the app generates an alert (e.g., audible tone, vibration, and/or visual notification) to notify the user.
The app operates in real-time without storing or transmitting audio data to ensure privacy.

### 4.2 User Interface and Functionality

Keyword Input: Users can manually add, edit, or remove keywords within the app's settings.
Alert System: Upon detecting a keyword, the app triggers a notification.
Activation & Control: Users can toggle the app on/off or adjust sensitivity levels.
Customization: The app allows users to select different alert tones or vibration feedback options.

### 4.3 Technical Implementation

Utilizes speech-to-text APIs for real-time keyword detection.
Employs efficient processing strategies to reduce battery consumption.
Designed with privacy-focused architecture to process audio locally on the device.

### BRIEF DESCRIPTION OF THE DRAWINGS

No drawings.

1. A computer-implemented method performed by a mobile device, comprising:
receiving audio of a conversation via a microphone during an active monitoring session initiated by a user;
converting the received audio to text using speech-to-text processing;
comparing the text to a user-configurable list of keywords or phrases to determine a match; and
in response to determining the match, generating an alert to the user via at least one of an audible tone, vibration, or a visual notification.

2. The method of claim 1, wherein the user-configurable list of keywords or phrases is editable through a user interface that allows adding, editing, and removing entries.

3. The method of claim 1, further comprising enabling and disabling the active monitoring session in response to user input.

4. The method of claim 1, further comprising applying a sensitivity setting that affects match detection.

5. The method of claim 1, wherein the mobile device processes the audio locally and does not store or transmit audio.

6. The method of claim 1, wherein the alert includes a selectable alert tone and/or vibration feedback option.
